(19) United States
(12) Patent Application Publication
(10) Pub. No.: US 2014/0099201 A1
(43) Pub. Date: Apr. 10, 2014

(54) Energy Recovery of Accelerating Slipstream

(71) Applicant: Kevin Leslie Thomazios, San Jose, CA (US)

(72) Inventor: Kevin Leslie Thomazios, San Jose, CA (US)

(21) Appl. No.: 13/645,468

(22) Filed: Oct. 4, 2012

(51) Int. Cl. F03D 1/02

(52) U.S. Cl. CPC F03D 1/025
USPC 416/1; 416/124

(57) ABSTRACT

One embodiment comprising a motoring propeller (21) attached to a rotatable motoring shaft (22) which in turn is connected to a motor (26) and a generating propeller (23) attached to a rotatable generating shaft (24) which in turn is connected to a generator (25). Operation of the motor (26) results in the motoring propeller (21) to rotate and generate an accelerating slipstream towards the generating propeller (23) which results in the generator (25) rotating to convert recovered rotational energy into other forms of useable energy. The motoring propeller (21) may also be represented as rotating spokes of a wheel rim with the generating propeller (23) situated inside or near the wheel rim space where it freely rotates as a result of the slipstream impacting its blades. The motor (26) may be an electric motor or an internal combustion engine. The generator (25) output is available for charging batteries or powering electrical loads.

### BACKGROUND

### Description of Prior Art

The following is a tabulation of some prior art that presently appears relevant:

U.S. Patents

| Patent Number | Kind Code | Issue Date | Patentee |
|---|---|---|---|
| 1,431,683 | | 1922 Oct. 10 | Ramsay |
| 2,006,805 | | 1935 Jul. 02 | Gwinn |
| 7,552,787 | B1 | 2009 Jun. 30 | Williams |
| 7,624,830 | B1 | 2009 Dec. 01 | Williams |
| 8,172,022 | B2 | 2012 May 08 | Schneidewind |

U.S. Patent Application Publications

| Publication Nr. | Kind Code | Issue Date | Patentee |
|---|---|---|---|
| 2011/0272951 | A1 | 2011 Nov. 10 | Marchand |

Propellers or fans driven by a machine such as a motor, generate thrust by accelerating the air as it moves past the rotating blades, thus causing a pressure differential resulting in a net force. The flow of accelerating air past the blades is typically known as slipstream which has gained energy from the interaction with the rotating blades and continues to accelerate until its velocity peaks some distance behind the propeller. Slipstream is typically put to use as fast flowing air in commercial fans ranging from small domestic consumer fans to larger cooling fans found in industrial applications. Aside from this application, slipstream is considered a by-product of the thrust generation process and is largely ignored and unused. Instead, the primary application of rotating blades or spokes is to provide a propulsive force such as thrust in airplanes and ships or deliver torque through rotating hubs and spokes of wheels in ground-based vehicles. It then follows that this wasted slipstream energy could be recovered for the benefit of making additional energy available for prolonged operation and improved performance in battery-powered machines and moving vehicles.

In U.S. Pat. No. 1,431,683 by Ramsay, issued 1935-10-10, it was proposed to use the slipstream with a second propeller primarily as an early form of air brake to shorten the landing distance of an airplane. Alternative uses of slipstream are mentioned as ‘to provide power for any purpose which may be desired’ through the use of a gear situated on a clutch system. The invention uses a single shaft driven by a single prime mover to rotate both propellers in the same direction. The propellers are physically in contact with each other through the use of sleeves which clearly implies frictional interference between the propellers. Adding to the complexities, the proposed apparatus has the second propeller ‘opposite-handed’ which meant the trailing edge of the blades of the second propeller faces the trailing edge of the blades of the first propeller. This arrangement results in high frictional losses and questionable efficiency of the second propeller. In addition, the patent makes no mention of the resulting excessive torque with respect to its use in airplanes considering that both propellers are rotating in the same direction. To the knowledge of this author, this apparatus never saw widespread utility.

In U.S. Pat. No. 2,006,805, by Gwinn, issued 1935-07-02, although titled as ‘Vane for Recovery of Energy in Propeller Slipstream’, it actually proposed to eliminate the rotational component of slipstream to improve airplane stability and handling. The method used fixed vanes installed around an airplane engine cowling in an effort to eliminate the tangential or rotational component of slipstream, leaving primarily the axial component. The key result of this method was improved handling of the airplane by the elimination of yaw about the center of gravity of the airplane. Ultimately, the patent was more about eliminating the rotational component of slipstream than recovering its energy as a whole for other uses. The rapid pace of aviation technology development and improved pilot techniques by the 1930s rendered this method obsolete before it could establish itself in the industry. It is cited here because of its use of the term ‘slipstream energy recovery’ which could be potentially confusing with respect to the present method and apparatus being proposed by this author.

The scope of the present patent includes an application for wheel energy recovery, so a short clarification of wheel energy recovery systems should be addressed. In U.S. Pat. No. 7,552,787 by Williams, issued 2009-06-30, U.S. Pat. No. 7,624,830 by Williams, issued 2009-12-01 and U.S. Pat. No. 8,172,022, by Schneidewind, issued 2012-05-08, energy recovery systems in wheels are covered. The aforementioned three patents make primary use of flywheels situated in or near wheels. Flywheels are used to store and release energy depending on whether the vehicle is accelerating or decelerating. However, dependency on acceleration and deceleration for energy is both unpredictable and inconsistent because a vehicle system cannot predict when the driver will be accelerating or braking. The duration of acceleration and braking, which determines how much energy is collected or released, is also highly variable for each acceleration or deceleration event. Thus, the amount of energy collected is inconsistent. Owners and drivers are unable to reliably predict how much energy their vehicles will have for their required range and payload combinations. Vehicle manufacturers using this approach for wheel energy recovery face a complex solution that does little to improve the range and payload issues currently facing state-of-the-art electric vehicles.

In U.S. Patent Application Publication 2011/0272951 by Marchand, published 2011-11-10, it is proposed to use a pair of propellers rotating in opposite directions to one another to drive a single generator. The first propeller acts as a windmill generating slipstream behind it. The second or aft propeller is downstream of the decelerating slipstream. Both propellers are optionally mechanically linked to each other to ensure the propellers are rotating at identical speeds. However, as an energy recovery method, the use of decelerating slipstream generated by the first propeller is limiting. The slipstream generated by the first propeller slows down even as it impacts the blades of the second propeller. The second propeller also works against the rotational component of the slipstream, additionally reducing the efficiency of the energy recovery process. Furthermore, the mechanical linkage between the propellers prevents each propeller from achieving its full potential of rotational energy independently while also adding the inertia of each propeller to the other when they are linked.

### SUMMARY

In accordance with one embodiment, an accelerating slipstream energy recovery method or apparatus comprising a pair of rotating propellers, or a set of spokes and a propeller, connected to a pair of rotatable shafts which in turn are connected to a motor and a generator. The benefit of this configuration is that the first propeller generates accelerating slipstream energy for recovery by the second propeller in the form of rotational energy for conversion by the generator as desired.

### Advantages

Accordingly, several advantages of one or more aspects are as follows: that permits energy recovery of accelerating slipstream, that permits energy recovery in a compact configuration, that permits energy recovery with or without the use of gears or clutches, that permits energy recovery with or without concentric rotatable shafts, that permits energy recovery whether the pair of propellers are rotating in the same direction or opposite relative to each other, that permits energy recovery without the generating and motoring sections being connected or in contact with each other, that permits energy recovery in vehicles where the direction of motion is perpendicular to the axes of rotation of the propellers, that permits more predictable and consistent energy recovery in electric energy vehicles, that permits electric fans or cooling systems in battery-powered equipment to generate electrical energy. Other advantages of one or more aspects will be apparent from a consideration of the drawings and ensuing description.

### DRAWINGS

### Descriptions of Figures

In the drawings, each figure has the same first digit identifying the embodiment it belongs to followed by an alphabet identifier to distinguish each unique drawing belonging to that embodiment.

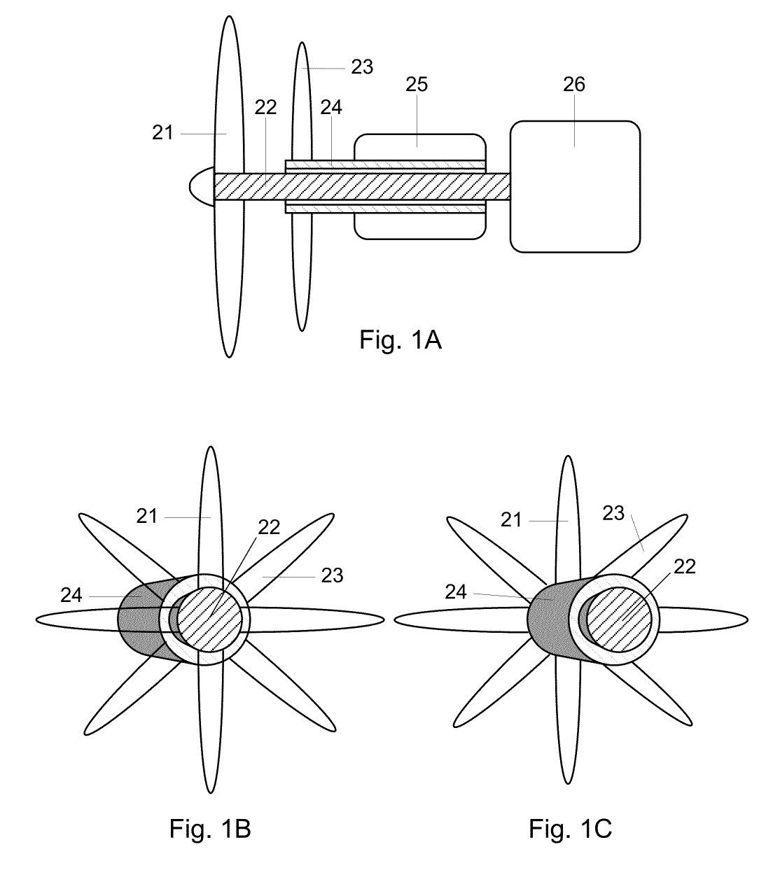

FIG. 1A shows an orthogonal view of the first embodiment.

FIG. 1B shows the front perspective view of co-axial and concentric shafts with their respective propellers.

FIG. 1C shows the rear perspective view of co-axial and concentric shafts with their respective propellers.

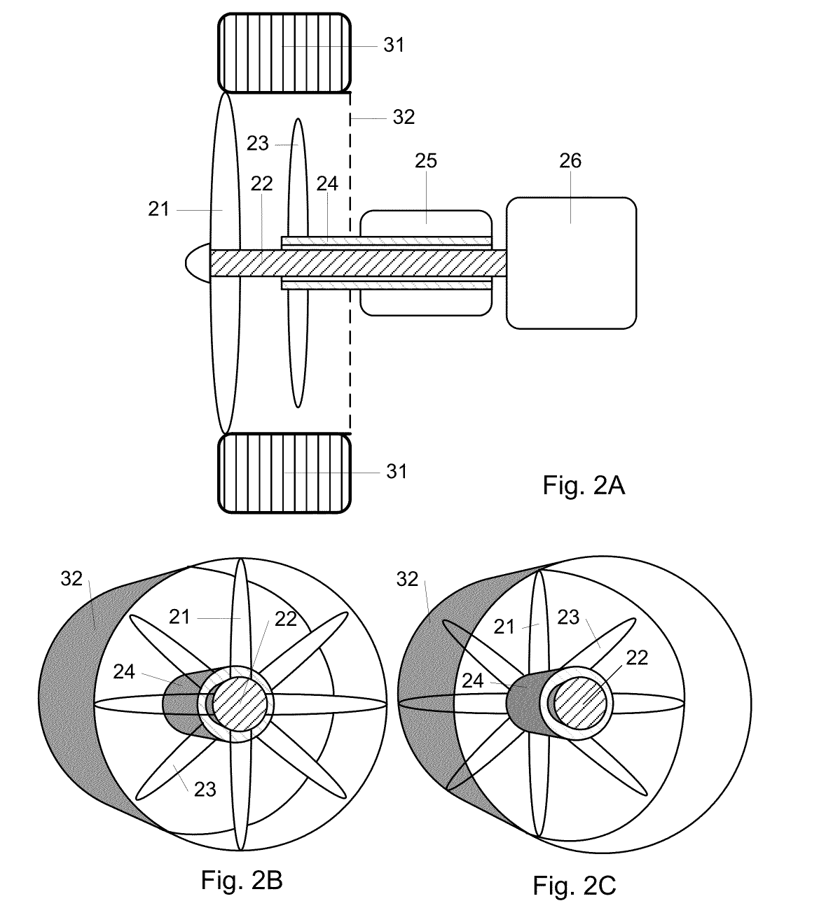

FIG. 2A shows an orthogonal view of an alternative embodiment in a wheel energy recovery application.

FIG. 2B shows the front perspective view of co-axial and concentric shafts with spokes within a wheel rim.

FIG. 2C shows the rear perspective view of co-axial and concentric shafts with spokes within a wheel rim.

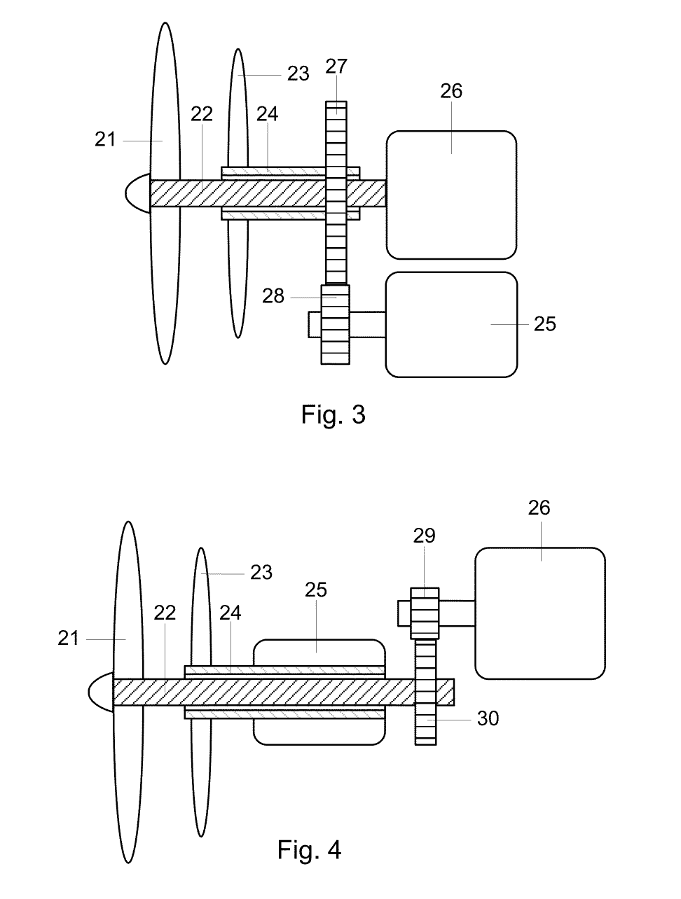

FIG. 3 shows an alternative embodiment with a generator geared to its shaft.

FIG. 4 shows an alternative embodiment with a motor geared to its shaft.

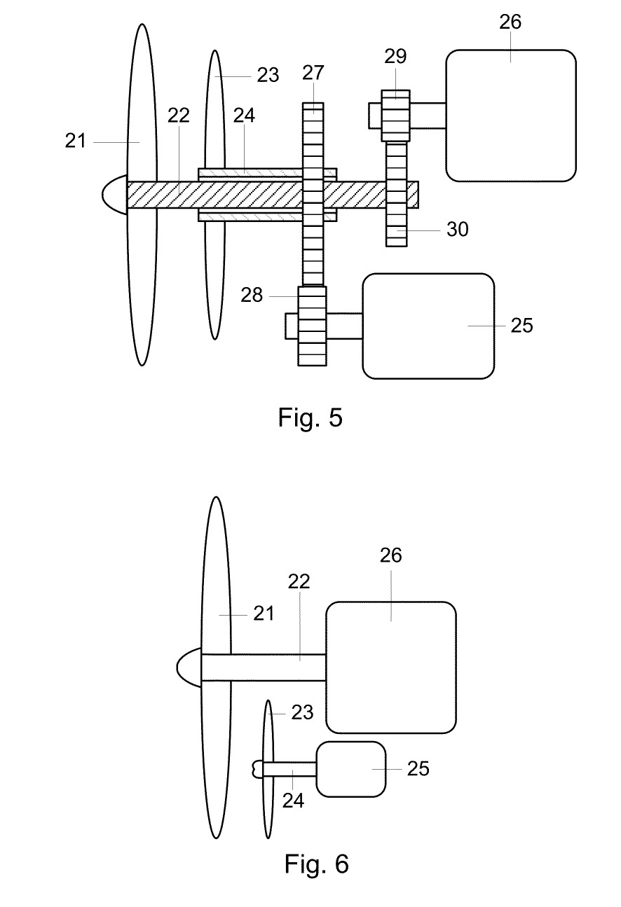

FIG. 5 shows an alternative embodiment with a motor and a generator geared to their respective shafts.

FIG. 6 shows an alternative embodiment illustrating parallel rotatable shafts without a common axis of rotation.

### REFERENCE NUMERALS

Each reference numeral listed below is unique and identifies the same element or component across all figures:

21 Motoring/First propeller or spokes
22 Motoring shaft
23 Generating/Second propeller
24 Generating shaft
25 Generator
26 Motor
27 Generating gear
28 Generating pinion
29 Motoring pinion
30 Motoring gear
31 Tire
32 Wheel rim

### DETAILED DESCRIPTION

For each embodiment, there is a unique number assigned and described in the following order of sub-sections: Configuration, Operation, Advantages.

### First Embodiment—Configuration—FIGS. 1A, 1B, 1C

The first embodiment illustrated in FIG. 1A depicts one possible configuration for a method or apparatus generating an accelerating slipstream and then recovering energy from that slipstream. A motoring propeller 21 is attached to a rotatable motoring shaft 22 which in turn is connected to a motor 26. These elements comprise what will be referred to as the motoring section. A generating propeller 23 is attached to a rotatable generating shaft 24 which in turn is connected to a generator 25. These elements comprise what will be referred to as the generating section.

As depicted in FIG. 1A, there are no physical connections or contacts between the propellers. To ensure optimum performance, it is recommended that there should be no interference or obstruction in the flow of air from motoring propeller 21 to generating propeller 23.

Each propeller may have different numbers of blades and different diameters. The arithmetic ratio of the diameters of generating propeller 23 to motoring propeller 21 is known as the diameter ratio. There is no requirement for a specific diameter ratio between the propellers. However, it has been discovered by the author that the optimal diameter ratio is approximately between 0.725 and 0.775. A specific optimal ratio should be determined empirically for each embodiment. Regarding the number of blades, generally the more blades on motoring propeller 21, the greater the slipstream produced, benefitting the generating system. Similarly, the greater the number of blades on generating propeller 23, the higher the rotational speed thus, the greater the rotational energy production. FIG. 1A depicts each propeller having four blades which is the highest performing configuration investigated by the author. This is in no way the required number of blades or limiting the general functionality of the method or apparatus in any way.

Blade design can have a significant effect on performance. Blade design includes such factors as blade area, pitch, twist, airfoil, chord, thickness, hub area, and type of material. There are no requirements or specifications for these factors other than the choice of these factors should enable motoring propeller 21 to produce accelerating slipstream when commanded to rotate and generating propeller 23 should be able to be rotated by the accelerating slipstream. Most commercially available propellers at all scales will meet this requirement and persons skilled in the art should be reasonably familiar with these choices. It is also recommended that the material used to construct the propellers should be of a lightweight nature. This is ensures a mechanically low inertia for generating propeller 23 that will allow greater efficiency and performance. A lighter weight motoring propeller 23 also reduces the load on motor 26, allowing the motoring section of the system to rotate at higher speeds.

The two rotatable shafts 22 and 24 are depicted in FIG. 1A as concentric and sharing a common axis of rotation. Motoring shaft 22 rotates within generating shaft 24 with motoring shaft 22 extending beyond the end of generator 25 and into motor 26. There is no physical connection or contact between the two shafts which requires generating shaft 24 to be sufficiently and consistently hollow along its length to allow motoring shaft 22 to be aligned with the same axis of rotation while delivering rotational energy to motoring propeller 21. In this embodiment, the requirement for generating shaft 24 be sufficiently and consistently hollow not only benefits motoring shaft 22 but also ensures generating shaft 24 is freely rotatable to deliver as much recovered rotational energy as possible from generating propeller 23 to generator 25 without mechanical interference from the motoring section. There is no requirement for motoring shaft 22 to be hollow in this embodiment. FIGS. 1B and 1C are front and back perspective views to aid the reader in the understanding of the co-axial and concentric rotatable shafts.

Motor 26 produces rotational energy. This rotational energy, derived from an energy source conversion such as an electric charge via battery or fossil fuels, is delivered to motoring propeller 21 via the rotatable motoring shaft 22. Motor 26 may be an electric motor of any kind or an internal combustion engine. Generator 25 recovers the rotational energy produced by generating propeller 23, and via its associated generating shaft 24, converts that energy into a useable form such as direct current electricity. Generator 25 may be a direct or alternating current electric generator of any kind or a mechanical device that utilizes the recovered rotational energy.

FIG. 1A depicts both generator 25 and motor 26 as being directly mounted around generating shaft 24 and motoring shaft 22, respectively. For the motoring section, this is accomplished by having the external motor shaft, which is itself part of the motor's rotor, joined or coupled to motoring shaft 22 or having a motor with a sufficiently long shaft built in with the motor thereby integrating motoring shaft 22 with motor 26. For the generating section, generating shaft 24 can be accomplished similarly with the additional requirement that the shaft be hollow to allow for motoring shaft 22 as previously described. The direct mounting of motor 26 and generator 25 around their respective shafts is generally not a requirement for the method to function but enables an embodiment both physically compact and efficient. As will be shown, alternative embodiments will allow either the motor or generator, or both, to be situated away from the shafts using other techniques such as gearing.

It may be appropriate to provide support bearings (not shown) to the shafts, particularly in instances where the shafts are long or where the shaft materials lack the appropriate stiffness, for example, when the weight of the propeller at the end of the shaft causes the shaft to bend or flex during rotation. Such bearings should be of the lowest possible resistance and persons skilled in the art are advised to choose such bearings with care, particularly where generating shaft 24 is concerned. It is recommended that support bearings, if needed, should be situated as close to the propellers as possible, for example, support for motoring shaft 22 between motoring propeller 21 and generating propeller 23. Another example is support for generating shaft 24 between generating propeller 23 and the generator 25. Persons skilled in the art should be knowledgeable about overall installation of support bearings with respect to their own specific embodiment. Furthermore, it is recommended to persons skilled in the art that each propeller should be secured to its axial position on its respective shaft using a collar (not shown) to prevent the propeller from sliding along the shaft axially due to continuous or even momentary high thrust conditions. It should also be made clear that generator 25 and motor 26 in FIG. 1A are securely fixed to a base or installation (not shown) of some kind, depending on the application.

### First Embodiment—Operation—FIGS. 1A, 1B, 1C

When motor 26 is commanded to operate, it produces rotational energy that causes motoring shaft 22 to rotate. Motoring shaft 22 delivers the rotational energy to motoring propeller 21, causing it to rotate. It is a well established fact that rotating propellers produce a slipstream or the movement of air past the blades. Slipstream consists of axial and tangential components where the axial component is parallel to the axis of rotation while the tangential component is perpendicular to the axis of rotation. Typically, the axial component is by far the more dominant component. The speed of slipstream is dependent on several factors such as propeller rotation speed, the speed of undisturbed air before reaching the blades, and the previously mentioned blade design factors. Slipstream flowing from the back of the blades of motoring propeller 21 pass through and around the blades of generating propeller 23. The force of slipstream impacting the blades on generating propeller 23 gives rise to rotation of generating propeller 23. This is the fundamental act of recovering the energy in the slipstream. Generating propeller 23 converts the slipstream energy into rotational energy which then causes generating shaft 24 to rotate. Generating shaft 24 delivers rotational energy to generator 25 which then converts the rotational energy into a form of energy to be utilized as desired. For example, an electrical generator converting the rotational energy into electrical energy which is then used to charge batteries or power other electrical equipment as needed.

Operation of the motoring section is in no way dependent on the generating section. However, operation of the generating section is dependent on the motoring section for the required slipstream. As mentioned earlier, there are no physical connections or contacts between the motoring and generating sections. This is to ensure that the generating section is recovering mostly what would otherwise be wasted energy. Energy used in powering the motoring section, specifically motor 26, is not used in the recovery of slipstream energy.

The degree of slipstream energy recovered is a direct function of the speed of slipstream at generating propeller 23. The faster the slipstream speed, the faster generating propeller 23 rotates, the more energy is recovered and converted to rotational energy. Consequently, when generating shaft 24 rotates faster, generator 25 converts more rotational energy into, for example, electrical energy. Conversely, the slower the slipstream, the slower the rotation of generating propeller 23, the less energy is recovered and converted to rotational energy resulting in less energy being converted by generator 25.

The direction of rotation of generating propeller 23 with respect to motoring propeller 21 has a significant effect on performance. There is no requirement as to the direction of rotation for motoring propeller 21 in any embodiment of the proposed method or apparatus; either clockwise or counter-clockwise is satisfactory. The same can be said of generating propeller 23. However, relative to one another, whether rotating in the same direction, hereinafter referred to as co-rotation, or opposite to each other, hereinafter referred to as counter-rotation, there is a significant difference in performance that requires careful consideration by persons skilled in the art. I have discovered co-rotation consistently outperforms counter-rotation by a significant margin in maximizing slipstream energy recovery. Co-rotation enables higher rotation speeds for generating propeller 23 but also produces higher thrust and torque effects for that propeller. As it will be seen in the description and operation of alternative embodiments, these thrust and torque effects of generating propeller 23 can be effectively dealt with depending on the specific embodiment and application. The embodiment in FIG. 1A can be used with either co-rotation or counter-rotation, as is the case for all embodiments described hereinafter.

The installed distance or separation between propeller hubs is a lesser factor affecting performance when compared to propeller speeds, diameter ratio, number of blades, and blade design. It is well understood from the Rankine-Froude momentum theory, developed in the second half of the 19th century, that the speed of slipstream generated by the motoring propeller 21 continues to accelerate such that its speed continues to increase for some distance behind the propeller until it peaks. Ideally, any attempt at recovering the energy in the slipstream occurs at the point of maximum speed of the slipstream. The location of the point of maximum slipstream speed along the axis of rotation in the embodiment of FIG. 1A is accomplished by empirical testing. Provisions should be made by persons skilled in the art to allow either motoring propeller 21 or generating propeller 23 to be adjusted along the axis of rotation until the desired performance is achieved. It should be pointed out that depending on the application, placement at the optimal location for generating propeller 23 may not be possible due to application constraints such as space or volume available. In such cases, it is recommended to persons skilled in the art that they determine the maximum allowable separation between the propellers, given the constraints of their specific embodiment, and then empirically determine the best performance achievable within that distance.

### First Embodiment—Advantages—FIGS. 1A, 1B, 1C

From the descriptions of configuration and operation, the following advantages of the first embodiment are evident:

(a) The absence of gears, also known as direct drive, reduces mechanical losses typically associated with gears.

(b) The load on motor 26 is reduced without gearing, allowing motor 26 to output more rotational energy per given unit of input energy thereby increasing efficiency of the motoring section. Increased efficiency of the motoring section improves the production of slipstream, resulting in the improved efficiency of slipstream energy recovery.

(c) The absence of gears reduces the overall inertia of the generating section, thereby improving the efficiency of the generating section.

(d) The use of concentric rotatable shafts reduces the lengths and weights of the shafts, as compared to non-concentric shafts, thus enabling a more compact embodiment and a more attractive commercial implementation.

(e) The use of concentric rotatable shafts results in weight savings contributing to lower overall inertia in the generating section, thus leading to improved generator 25 output.

(f) The weight savings from reduced shaft lengths and the use of direct drive reduces manufacturing costs.

(g) The simplicity of the first embodiment of FIG. 1A contributes to reliability and robustness as well compactness.

(h) The ability to recover slipstream energy regardless of whether the propellers are co-rotating or counter-rotating.

(i) The use of the proposed method and the embodiment of FIG. 1A enable a battery-operated system with a cooling fan to recover the slipstream generated by the fan, or motoring propeller 21, and generate electrical energy which could be used to power the system, thereby off-loading the battery and extending the operation of the system. The present method or apparatus could also be used for battery back-up applications where a loss of mains power would default to battery operation and the method or apparatus would help to extend the operation of the system until mains power is restored.

### Alternative Embodiment 2—Configuration—FIGS. 2A, 2B, 2C

The embodiment of FIG. 2A illustrates a wheel energy recovery application whereby the spokes radiating from a wheel hub to a wheel rim 32 are the functional equivalent of the blades of motoring propeller 21. The axis of rotation is perpendicular to the vehicle's direction of motion. As the vehicle moves, the wheel rotates generating slipstream through the spokes and into the wheel rim cavity itself. As in the first embodiment of FIG. 1A, the slipstream impacts the blades of generating propeller 23, causing the rotation of generating shaft 24 connected to generator 25. It is highly recommended that the spokes are aerodynamically shaped as much as possible without compromising their ability to provide structural support to the wheel rim. Persons skilled in the art should be able to accomplish the design of wheel spokes that are functionally equivalent to that of the blades of a propeller.

### Alternative Embodiment 2—Operation—FIGS. 2A, 2B, 2C

Operation of the embodiment of FIG. 2A is effectively similar in all respects to the operation of the first embodiment of FIG. 1A. Being a vehicle application, motor 26 may be in the form of an electric motor, as used in all-electric or hybrid vehicles, or even an internal combustion engine. The output from generator 25 can be used to charge the vehicle's batteries, power the electrical accessories in the vehicle or even replace the alternator found in internal combustion vehicles. Due to the enclosure of the wheel rim, there may be minor performance improvements as a result of lower losses of slipstream energy.

### Alternative Embodiment 2—Advantages—FIGS. 2A, 2B, 2C

All the advantages of the first embodiment apply to the embodiment of FIG. 2A. In addition, from the descriptions of configuration and operation, the following advantages of this embodiment with respect to its wheel application are as follows:

(a) As the wheel rotates, it not only consumes energy enabling its rotation but also recovers energy in the slipstream caused by the rotating spokes of the wheel rim.

(b) As long as the vehicle that the wheel is attached to is moving, energy will be recovered. For the most part, state-of-the-art vehicles consume the energy they carry in storage at the beginning of each journey. State-of-the-art electric and hybrid vehicles are capable of recovering energy when brakes are applied which is a method known as regenerative braking. Regenerative braking is unpredictable and inconsistent. It is difficult to ascertain if one is braking and for how long. This makes the process of energy recovery marginally useful and much less dependable. The recovery of energy with the embodiment of FIG. 2A is significantly more predictable and consistent because it recovers energy while the vehicle is in motion and is not dependent on unpredictable events such as braking.

(c) The faster the wheel rotation, the greater the slipstream produced, the greater the energy recovered by the generating section. This is a basic feature of the method discussed in the first embodiment but is repeated here since it relates to vehicle speed. The faster the vehicle moves, the greater its energy consumption, but also, the greater its energy recovery. The benefit of this feature allows for a greater increase in cruising and maximum speeds of electric vehicles over longer sustained periods.

(d) The range of electric vehicles is improved with the application of this method using the embodiment of FIG. 2A because they would no longer be strictly limited by the charge capacity of on-board batteries. The output of generator 25 can be used to charge batteries while in motion or power accessories that would otherwise drain the batteries thereby reducing the discharge rate of batteries and extending the range of the vehicle.

(e) The payload, or useful carrying capacity, of electric vehicles is also improved with the application of this method using the embodiment of FIG. 2A because it reduces the need for as many batteries to be on-board as the state-of-the-art currently requires.

(f) Battery charging times and the number of charging cycles required is also reduced because of the mostly continuous charging taking place while the vehicle is in motion.

(g) The thrust and torque issues discussed in the first embodiment are effectively dealt with in vehicles where the direction of motion is perpendicular to the axis of rotation, such as automobiles. The wheel arrangement in automobiles is symmetrical such that the negative thrust experienced by generating propeller 23 on the left side is cancelled out by generating propeller 23 on the right side. Torque effects are minimized because the center of gravity of moving vehicles with tandem wheels, are typically between the sets of wheels.

(h) The use of the proposed method and its embodiment of FIG. 2A suggest an alternative application for internal combustion engine vehicles. Currently, the alternator is a major electromechanical accessory currently required to be driven by an auxiliary or serpentine drive belt connected to the internal combustion engine. The embodiment of FIG. 2A would eliminate the need for an alternator thereby improving the fuel efficiency of internal combustion vehicles.

### Alternative Embodiment 3—Configuration—FIG. 3

The embodiment of FIG. 3 illustrates an alternative to FIG. 1A by the possible use of gearing with generator 25. A generating gear 27 is mounted towards the rear of generating shaft 24. Generating gear 27 is engaged with a generating pinion 28 which could be a small gear in itself or a shaft or spindle cut with teeth as part of generator 25.

### Alternative Embodiment 3—Operation—FIG. 3

Operation of the embodiment of FIG. 3 is similar to the operation described for the first embodiment of FIG. 1A with the exception of the gear actions. When generator shaft 24 is rotated by generating propeller 23, generating gear 27 rotates and through the direct engagement of its gear teeth, generating pinion 28 consequently rotates. Generating pinion 28 then rotates generator 25, thereby completing the transfer of recovered slipstream energy from generating propeller 23 to generator 25.

### Alternative Embodiment 3—Advantages—FIG. 3

The advantage of this embodiment over the first embodiment is the flexibility in the configuration enabled by the of use gears thereby allowing for generator 25 to be situated unaligned from generating shaft 24. Generator 25 can now be more easily disassembled and even removed entirely for maintenance and repair. Additionally, for the purposes of product development, those skilled in the art will be able to more conveniently experiment with different generators by simply removing generator 25 and its generating pinion 28. Commercial-off-the-shelf generators can be used instead of custom made generators that would have to fit the specific diameter of generating shaft 24, as in the case of the first embodiment of FIG. 1A.

### Alternative Embodiment 4—Configuration—FIG. 4

The embodiment of FIG. 4 illustrates an alternative to FIG. 1A by the possible use of gearing motor 26. A motoring gear 30 is mounted towards the rear of motoring shaft 22. Motoring gear 30 is engaged with a motoring pinion 29 which could be a small gear in itself or a shaft or spindle cut with teeth as part of motor 26.

### Alternative Embodiment 4—Operation—FIG. 4

Operation of the embodiment of FIG. 4 is similar to the operation described for the first embodiment of FIG. 1A with the exception of the gear actions. When motor 26 is commanded to rotate, motoring pinion 29 rotates and through the direct engagement of its gear teeth, motoring gear 30 consequently rotates. Motoring gear 30 then rotates motoring shaft 22, thereby causing motoring propeller 21 to rotate and produce slipstream.

### Alternative Embodiment 4—Advantages—FIG. 4

The advantage of this embodiment over the first embodiment is the flexibility in the configuration enabled by the use of gears thereby allowing for motor 26 to be situated unaligned from motoring shaft 22. Motor 26 can now be more easily disassembled and even removed entirely for maintenance and repair. Additionally, for the purposes of product development, those skilled in the art will be able to more conveniently experiment with different motors by simply removing motor 26 and its motoring pinion 29. Commercial-off-the-shelf motors can be used instead of custom made motors that would have to fit the specific diameter of motoring shaft 22, as in the case of the first embodiment of FIG. 1A.

### Alternative Embodiment 5—Configuration—FIG. 5

The embodiment of FIG. 5 illustrates an alternative to FIG. 1A by having both motor 26 and generator 25 geared as previously described individually in alternative embodiments 3 and 4.

### Alternative Embodiment 5—Operation—FIG. 5

Operation of the embodiment of FIG. 5 is similar to the operation described for the first embodiment of FIG. 1A with the additional descriptions of operations for alternative embodiments 3 and 4.

### Alternative Embodiment 5—Advantages—FIG. 5

The advantage of this embodiment over the first embodiment is the flexibility in the configuration enabled by the of use gears thereby allowing for motor 26 and generator 25 to be situated unaligned from both motoring and generating shafts 22, 24, respectively. The advantages of alternative embodiments 3 and 4 are fully applicable in this embodiment.

### Alternative Embodiment 6—Configuration—FIG. 6

The embodiment of FIG. 6 illustrates an alternative configuration where the axes of rotation of motoring shaft 22 and generating shaft 24 are parallel but not co-axial. Motoring shaft 22 no longer needs to be hollow. The rest of elements and their interconnections are unchanged.

### Alternative Embodiment 6—Operation—FIG. 6

Operation of the embodiment of FIG. 6 is similar to the operation of the first embodiment of FIG. 1A. Operation of the motoring section is unchanged from the first embodiment. Generating propeller 23 remains in the slipstream of motoring propeller 21, enabling generating propeller 23 to generate rotational energy which then is delivered to generator 25 via generating shaft 24. The smaller generating propeller 23 depicted in FIG. 6 will undoubtedly produce less rotational energy but this can be offset by having more generating propellers behind motoring propeller 21.

### Alternative Embodiment 6—Advantages—FIG. 6

The advantage of this embodiment is that it allows for one or more, albeit smaller, generating propellers and/or sections arranged in a circular fashion around the motoring shaft 22.

### CONCLUSION, RAMIFICATIONS, AND SCOPE

Accordingly, the reader will see that in at least one embodiment, I have provided a method for energy recovery of accelerating slipstream generated by rotating bodies, such as propeller blades or spokes of wheel rims, which have the following advantages:
permits energy recovery in a compact configuration;
permits energy recovery with or without the use of gears;
permits energy recovery with or without common axes of rotation for motoring and generating propellers;
permits energy recovery whether the pair of propellers are co-rotating or counter-rotating;
permits energy recovery without the generating and motoring sections being connected or in contact with each other;
permits energy recovery in vehicles where the direction of motion is either parallel or perpendicular to the axis of rotation of the propellers;
permits more predictable and consistent energy recovery in electric energy vehicles thereby improving their range, payload, sustained speeds, and battery charging times;
permits the elimination of the alternator found in internal combustion engine vehicles and allowing for greater fuel efficiency;
permits electric fans or cooling systems in battery-powered equipment to generate electrical energy while consuming energy to drive the fan, effectively extending battery capacity allowing for the equipment to continue operating for longer periods.

While the above description contains many specificities, these should not be construed as limitations on the scope of any embodiments, but as exemplifications of various embodiments thereof. Many other ramifications and variations are possible within the teachings of the various embodiments.

Thus, the scope should be determined by the appended claims and their legal equivalents, and not by the examples given.

I claim:

1. A method for recovering wind energy, comprising:
a. generating an accelerating slipstream with a first propeller with means to rotate, and
b. providing a second propeller rotatable by said accelerating slipstream acting upon said second propeller,
whereby said second propeller produces rotational energy with means to deliver and use the rotational energy.

2. The wind energy recovery method of claim 1 wherein said first propeller is comprised of rotating spokes.

3. The wind energy recovery method of claim 1 wherein said second propeller has a diameter less than or equal to the diameter of said first propeller and the propellers are rotating in the same direction.

4. The wind energy recovery method of claim 1 wherein said second propeller has a diameter less than or equal to the diameter of said first propeller and the propellers are rotating in opposite directions relative to one another.

5. The wind energy recovery method of claim 1 wherein the means to rotate the first propeller is a motor connected to said first propeller via a rotatable shaft.

6. The wind energy recovery method of claim 1 wherein the means to rotate the first propeller is a motor connected to said first propeller via a rotatable shaft with a plurality of gears.

7. The wind energy recovery method of claim 1 wherein the means to deliver and use the rotational energy is a generator connected to said second propeller via a rotatable shaft.

8. The wind energy recovery method of claim 1 wherein the means to deliver and use the rotational energy is a generator connected to said second propeller via a rotatable shaft with a plurality of gears.

9. The wind energy recovery method of claim 1 wherein said first propeller is comprised of rotating spokes, said second propeller has a diameter less than or equal to the diameter of said first propeller, the propellers are rotating in the same direction, a motor provides rotational energy as means to rotate said first propeller, and said second propeller provides rotational energy to a generator via a rotatable shaft as means to deliver and use the rotational energy.

10. An apparatus for recovering wind energy, comprising:
a. a motoring propeller with means for producing an accelerating slipstream, and
b. a generating propeller rotatable by said accelerating slipstream,
whereby said accelerating slipstream causes said generating propeller to rotate thereby producing rotational energy with means to deliver and use the rotational energy.

11. The wind energy recovery apparatus of claim 10 wherein said motoring propeller is comprised of rotating spokes.

12. The wind energy recovery apparatus of claim 10 wherein the means to produce said accelerating slipstream is a motor connected to said motoring propeller via a rotatable shaft.

13. The wind energy recovery apparatus of claim 10 wherein the means to produce said accelerating slipstream is a motor connected to said motoring propeller via a rotatable shaft with a plurality of gears.

14. The wind energy recovery apparatus of claim 10 wherein the means to deliver and use the rotational energy is a generator connected to said generating propeller via a rotatable shaft.

15. The wind energy recovery apparatus of claim 10 wherein the means to deliver and use the rotational energy is a generator connected to said generating propeller via a rotatable shaft with a plurality of gears.

16. An apparatus for recovering wind energy, comprising:
a. a motoring propeller connected to a motor via a motoring shaft with said motoring propeller producing an accelerating slipstream when said motor is in operation, and
b. a generating propeller connected to a generator via a generating shaft,
whereby said accelerating slipstream causes said generating propeller to rotate thereby producing rotational energy which is delivered to said generator via said generating shaft.

17. The wind energy recovery apparatus of claim 16 wherein said motoring propeller is comprised of rotating spokes.

18. The wind energy recovery apparatus of claim 16 wherein said motoring shaft is connected to said motor and said motoring propeller via a plurality of gears.

19. The wind energy recovery apparatus of claim 16 wherein said generating shaft is connected to said generator and said generating propeller via a plurality of gears.

20. The wind energy recovery apparatus of claim 16 wherein said motoring propeller is comprised of spokes, said motoring shaft is connected to said motor and said motoring propeller via a plurality of gears, and said generating shaft is connected to said generator and said generating propeller via a plurality of gears.
